(19) United States
(12) Patent Application Publication
(10) Pub. No.: US 2026/0073254 A1
(43) Pub. Date: Mar. 12, 2026

(54) Advanced Routing And Multi-Index Fusion For Enhanced Retrieval Augmented Generation

(71) Applicant: Oracle International Corporation, Redwood Shores, CA (US)

(72) Inventors: Mengqing Guo, Redmond, WA (US); Rongguang Wang, Seattle, WA (US); Yazhe Hu, Bellevue, WA (US); Zheng Wang, Sammamish, WA (US); Xin Zhang, Seattle, WA (US); Zhonghai Deng, Redmond, WA (US); Yimo Liu, Seattle, WA (US); Tao Sheng, Bellevue, WA (US)

(73) Assignee: Oracle International Corporation, Redwood Shores, CA (US)

(21) Appl. No.: 18/916,286

(22) Filed: Oct. 15, 2024

Related U.S. Application Data
(60) Provisional application No. 63/691,429, filed on Sep. 6, 2024.

(51) Int. Cl. G06N 5/04; G06F 16/901

(52) U.S. Cl. CPC G06N 5/04; G06F 16/901

(57) ABSTRACT

Techniques for multi-index retrieval in knowledge databases to enhance retrieval augmented generation (RAG) systems. The techniques involve a query processor that receives a query from a RAG agent, compares it to index summaries, and selects target indexes. The processor then searches these indexes, fuses the retrieved content items, and reranks the results before sending them back to the RAG agent. This approach combines query routing, multi-index fusion, and reranking to improve information retrieval for RAG applications. The technique offers several advantages, including enhanced retrieval efficiency through specialized indices, increased relevance and precision of retrieved information, scalability for large datasets and high query volumes, and optimized querying across diverse data sources. The techniques address challenges in managing extensive, distributed datasets and are compatible with existing RAG frameworks, providing a solution for complex information retrieval tasks.

### PRIORITY CLAIM

This application claims the benefit of priority of U.S. provisional patent application No. 63/691,429 filed Sep. 6, 2024, the entire contents of which are hereby incorporated by reference as if fully set forth herein.

### TECHNICAL FIELD

This disclosure relates generally to data retrieval. More particularly, this disclosure relates to data retrieval in multi-index database systems.

### BACKGROUND

Generative artificial intelligence (AI) agents are conversational systems powered by large language models (LLMs) trained on vast amounts of text data. These models, sometimes based on transformer architectures, use self-attention mechanisms and deep neural networks to generate human-like responses to user inputs. They operate by predicting the most likely sequence of tokens given a prompt, leveraging patterns learned from their training data. While powerful, these systems often struggle with up-to-date information, factual accuracy, and consistency across interactions due to their reliance on static, pre-trained knowledge.

Retrieval Augmented Generation (RAG) is an advanced natural language processing (NLP) technique that combines information retrieval with text generation to produce more accurate and contextually relevant outputs. This approach enhances LLMs by incorporating external knowledge sources during the generation process.

A database index (also referred to herein as an index) is a data structure that improves the speed of data retrieval operations on a database table. Indexes are used to quickly locate and access the data within a database table without having to search every row in the table when a database query is performed. Indexes significantly speed up the retrieval of data by reducing the amount of data that needs to be scanned. In addition, indexes help to quickly retrieve sorted data based on the indexed columns. By narrowing down the search space, indexes reduce the number of input/output (I/O) operations required to fetch the data.

In some cases, a single index is not sufficient for the given data storage needs. Some systems use multiple indexes, either in the same database or across multiple databases. Having multiple indexes can result in diminishing returns on query performance if every query is submitted to all the indexes.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

One or more embodiments of the present disclosure are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example multi-tenant provider network environment in which techniques for advanced routing and multi-index fusion for enhanced retrieval augmented generation are implemented in accordance with an embodiment of the present disclosure;

FIG. 2 is a flowchart of a method for advanced routing and multi-index fusion for enhanced retrieval augmented generation implemented in accordance with an embodiment of the present disclosure;

FIG. 3 illustrates an example of advanced routing and multi-index fusion for enhanced retrieval augmented generation in accordance with an embodiment of the present disclosure; and

FIG. 4 illustrates an example computer system for use in an implementation of advanced routing and multi-index fusion for enhanced retrieval augmented generation in accordance with an embodiment of the present disclosure.

### DETAILED DESCRIPTION

In the following detailed description, for the purposes of explanation, numerous specific details are set forth to aid understanding of one or more embodiments of the present disclosure. In some instances, an embodiment of the present disclosure may be practiced without one or more of these specific details. In some cases, a described feature of one embodiment of the present disclosure is also a feature of one or more other embodiments of the present disclosure even though the feature is not expressly described with respect to the one or more other embodiments. In some embodiments, well-known structures and devices are shown in the figures in block diagram form to avoid unnecessarily obscuring the embodiment.
1. GENERAL OVERVIEW
2. SYSTEM FOR ADVANCED ROUTING AND MULTI-INDEX FUSION FOR ENHANCED RETRIEVAL AUGMENTED GENERATION
3. METHOD FOR ADVANCED ROUTING AND MULTI-INDEX FUSION FOR ENHANCED RETRIEVAL AUGMENTED GENERATION
4. EXAMPLE EMBODIMENT
5. COMPUTER NETWORKS AND CLOUD NETWORKS
6. HARDWARE OVERVIEW
7. MISCELLANEOUS; EXTENSIONS

### 1. General Overview

One or more embodiments perform multi-index retrieval in a knowledge database to support retrieval augmented generation (RAG). One or more embodiments include a query processor receiving an information retrieval query from a RAG agent. The query processor compares this query to summaries of multiple indexes. Based on this comparison, the query processor selects a set of target indexes. The query processor submits the query to search within the selected target indexes and receives sets of content items identified as relevant from each target index. These sets are fused by the query processor into a single combined set. The fused set is then reranked by the query processor to produce a final reranked set of content items. This reranked set is sent by the query processor back to the RAG agent. The approach combines query routing to select relevant indexes with multi-index fusion and reranking to retrieve more relevant and precise information for the RAG system thereby improving the operation of the RAG system and addressing challenges in managing large-scale distributed datasets for RAG applications.

One or more embodiments improve performance of multi-index systems by submitting queries to the specific indexes that are most relevant to the query, thus sparing computing resources that would otherwise have been spent querying more indexes than necessary.

One or more embodiments offer several advantages for RAG systems. One or more embodiments enhance retrieval efficiency using specialized indices. These indices are tailored to different data types and retrieval needs. One or more embodiments increase the relevance and precision of retrieved information. This results in more accurate and contextually appropriate responses from the RAG agent. One or more embodiments are designed to be scalable and can handle large datasets and high query volumes. This ensures robust performance even as data and usage grow. The multi-index approach allows for optimized querying across diverse data sources. One or more embodiments combine query routing with fusion and reranking techniques. This combination improves the quality of information retrieval. One or more embodiments can efficiently manage and search multiple indices simultaneously to address challenges in dealing with extensive, distributed datasets. One or more embodiments are compatible with existing RAG frameworks. One or more embodiments provide a solution for complex information retrieval tasks in RAG applications.

While the techniques can be employed with RAG systems and in multi-tenant environments, one or more embodiments are generalized to non-RAG and single-tenant systems for efficient multi-index information retrieval. In such systems, a query processor receives an information retrieval query from a client application. The processor compares the query against summaries of multiple indexes to select a set of target indexes most relevant to the query. This query routing approach optimizes resource utilization by focusing search efforts on the most promising data sources. The query is then executed against the selected indexes, and the resulting sets of relevant content items are fused into a single combined set.

To further refine results, the fused set undergoes a reranking process in one or more embodiments. This reranking produces a final ordered set of content items that is returned to the querying application. The combination of targeted index selection, multi-index fusion, and reranking enhances retrieval precision and relevance across diverse data sources. These techniques can improve performance in large-scale distributed datasets beyond RAG-specific use cases. The approach remains scalable and compatible with various information retrieval frameworks, offering benefits in managing complex queries and extensive data collections in non-RAG and single-tenant environments.

One or more embodiments described in this Specification and/or recited in the claims may not be included in the General Overview section.

### 2. Multi-Tenant Provider Network Environment

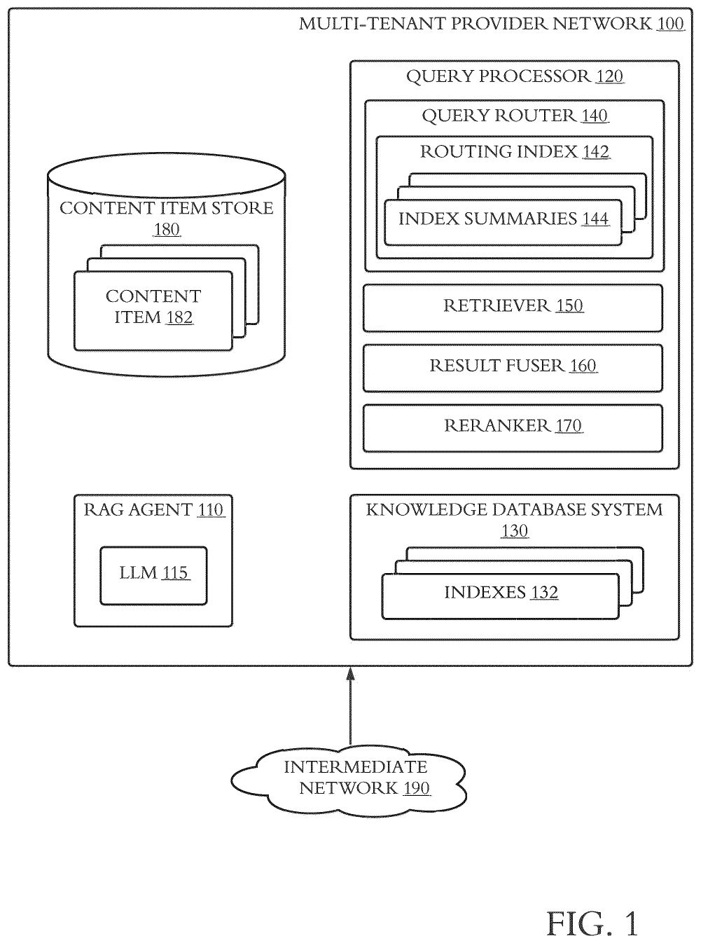

FIG. 1 illustrates an example multi-tenant provider network environment in which techniques for advanced routing and multi-index fusion for enhanced retrieval augmented generation are implemented in accordance with one or more embodiments of the present disclosure.

In one or more embodiments, multi-tenant provider network 100 is a cloud computing architecture. Multi-tenant provider network 100 serves multiple customers or “tenants” simultaneously that share software application and infrastructure. The multi-tenant provider network 100 isolates a tenant's data and configuration to a degree to ensure security and privacy between tenants. Resources are dynamically allocated by the multi-tenant provider network 100 based on tenant needs to maximize efficiency and reduce costs.

In one or more embodiments, the provider of the multi-tenant provider network 100 manages the underlying infrastructure and software on behalf of tenants that access services provided by the multi-tenant provider network 100 through web interfaces or application programming interfaces (APIs). The multi-tenant provider network 100 scales horizontally to accommodate growing numbers of tenants and allows for customization within a tenant's provisioned environment with the multi-tenant provider network 100. Updates and maintenance are performed centrally by the provider to reduce the burden on individual tenants.

In one or more embodiments, the multi-tenant provider network 100 offers to tenants various services, like computing, storage, and databases, and enables rapid deployment and scaling of applications. Billing is based on resource usage, subscription models, or other suitable billing models. The architecture of the multi-tenant provider network 100 supports high availability and disaster recovery and provides a flexible platform for diverse business needs.

In one or more embodiments, the multi-tenant provider network 100 offers a RAG agent 110 to tenants as a service within the multi-tenant provider network 100. The RAG agent 110 is a specialized artificial intelligence (AI) system that combines a large language model (e.g., LLM 115) with an information retrieval component provided by the query processor 120. The RAG agent 110 processes user queries or prompts and uses the query processor 120 to retrieve relevant information from a knowledge database system 130. The retrieved information augments the LLM 115's knowledge base. This augmentation improves the accuracy and relevance of the LLM 115's responses to the user queries or prompts. The RAG agent 110 dynamically integrates external knowledge retrieved from the knowledge database system 130 by the query processor 120 with the LLM 115's internal pre-trained knowledge. This process allows the LLM 115 to access up-to-date or domain-specific information.

In one or more embodiments, tenants access the RAG agent 110 through a dedicated API or user interface (e.g., graphical user interface or command line interface). A tenant's data is stored in a knowledge database system 130 in logical or physically separate, isolated indexes 132. The query processor 120 handles requests from multiple tenants concurrently. The query processor 120 routes queries to the indexes 132 in the knowledge database system 130 appropriately on a tenant-specific basis. The query processor 120 scales resources dynamically based on tenant usage patterns. Tenant-specific configurations may be maintained by the query processor 120 for index selection or reranking. The fusion and reranking algorithms may be applied by the query processor 120 independently or separately for tenants. Billing may be based on the number of queries processed by the query processor 120 or data volume stored by the knowledge database system 130.

In one or more embodiments, the RAG agent 110 implements a reason plus action framework. The RAG agent 110 operates in alternating cycles of reasoning and acting. During reasoning phases, it generates structured thoughts about the task and context. In acting phases, it executes concrete actions based on its reasoning. The RAG agent 110 formulates queries to retrieve information from multiple indexes 132 of the knowledge database system 130 via the query processor 120. The RAG agent 110 uses the query processor 120 to gather relevant data. The RAG agent 110 reasons about retrieved information to plan subsequent steps. The RAG agent 110 can perform various actions, such as asking questions or refining search parameters. The framework enables multi-step reasoning and complex task decomposition. The RAG agent 110 maintains a working memory of past thoughts and actions. This memory informs future reasoning and action decisions. The RAG component augments the RAG agent 110's knowledge base dynamically. The RAG agent 110 adapts its approach based on intermediate outcomes and new information. The RAG agent 110 implements self-reflection to evaluate the effectiveness of its strategies. The framework allows the RAG agent 110 to handle multi-stage, open-ended tasks. The RAG agent 110 uses the query processor 120 to integrate external knowledge retrieval with internal decision-making processes. The RAG agent 110 provides explanations for its reasoning and justifications for actions taken. This approach enhances problem-solving capabilities and operational transparency.

In one or more embodiments, the RAG agent 110 incorporates a retrieval action in its action repertoire. The RAG agent 110 formulates an information retrieval query based on its current reasoning state. It sends this query to the query processor 120 for processing. The query processor 120 compares the query against index summaries 144 of indexes 132 available at the knowledge database system 130. The query processor 120 selects a set of target indexes based on relevance to the query. The knowledge database system 130 is then requested by the query processor 120 to search within these target indexes for pertinent information. A target index returns a set of content items matching the query criteria. The query processor 120 fuses these sets into a combined result set and applies a reranking algorithm to prioritize the most relevant content items. The reranked set of content items is returned by the query processor 120 to the RAG agent 110. The RAG agent 110 integrates this retrieved information into its knowledge context and uses the new information to inform its next reasoning phase. This retrieval action enables the agent to access up-to-date, domain-specific knowledge. The multi-index approach enhances the breadth and relevance of retrieved information. This process allows the RAG agent 110 to dynamically expand its knowledge base during task execution.

In one or more embodiments, the LLM 115 is an AI system for NLP based on neural network architectures such as transformer models. LLM 115 is trained on vast amounts of text data such as billions of words. By training, the LLM 115 learns to predict the probability distribution of words in a sequence. The LLM 115 contains millions or billions of parameters that encode complex patterns and relationships in language. The LLM 115 can generate human-like text responses and perform various tasks, such as translation, summarization, and question-answering. LLM 115 may use self-attention mechanisms to process input sequences and capture long-range dependencies in text effectively. Training the LLM 115 involves unsupervised learning on diverse text corpora. Fine-tuning adapts the models to specific tasks or domains. Inference is performed using techniques, like beam search or sampling. LLM 115 exhibits emergent behaviors not explicitly programmed and can reason about abstract concepts and solve complex problems. LLM 115 requires significant computational resources and is deployed on a distributed computing system. The LLM 115's capabilities scale with increased size and training data. LLM 115 may support few-shot learning and in-context learning abilities.

In one or more embodiments, the query processor 120 is a specialized component in the multi-index retrieval system. The query processor 120 contains a query router 140 that directs queries from the RAG agent 110. The query router 140 analyzes query characteristics to select appropriate target indexes and uses index summaries 144 in a routing index 142 to determine relevance for efficient routing. The retriever 150 executes the query across selected target indexes. The retriever 150 interfaces with the knowledge database system 130 to fetch matching content items. The retriever 150 optimizes search operations for a specific index type. The result fuser 160 aggregates content items from multiple indexes. The result fuser 160 combines results into a unified set, preserving metadata. The result fuser 160 handles potential duplicates and conflicts in the aggregated results. The reranker 170 evaluates the fused content items for relevance. The reranker 170 applies machine learning algorithms to prioritize the most pertinent results. The reranker 170 considers factors, such as query similarity and content quality. The reranker 170 produces a final ordered list of content items. This list is then returned to the RAG agent 110 as the query response. The entire process ensures efficient, relevant information retrieval across diverse data sources.

In one or more embodiments, the routing index 142 is a specialized data structure within the query router 140. The routing index 142 contains index summaries 144 of the indexes 132. These index summaries 144 capture characteristics of the underlying indexes 132. The routing index 142 uses efficient lookup mechanisms to map query terms or features to relevant index summaries. The routing index 142 supports fast comparison between queries and index contents by employing techniques, like term frequency-inverse document frequency (TF-IDF) or semantic embedding representations. The routing index 142 is updated to reflect changes in the underlying indexes. The routing index 142 can include metadata about index sizes, update frequencies, and content types. The routing index 142 supports various query matching algorithms for accurate routing decisions. For example, the routing index 142 may use vector representations for semantic similarity comparisons. The routing index 142 enables rapid identification of potentially relevant indexes and the search space for subsequent retrieval operations. The routing index 142 is optimized for low-latency access in high-throughput scenarios.

In one or more embodiments, the index summaries 144 are derived from the content of items indexed in each index 132. A summarization algorithm processes content items within an index. The algorithm extracts key terms, phrases, and concepts from the indexed content. The algorithm computes statistical measures, like TF and distribution. The algorithm identifies representative topics and themes across the index. The summary may include a compact vector representation of the index's content. Dimensionality reduction techniques may be applied to create concise summaries. The process preserves the most informative features of the indexed items. A summary captures the essential characteristics of its corresponding index. The summaries are updated periodically to reflect changes in index content. They may include metadata, such as content types and data ranges. The summarization process uses NLP techniques. The summarization process may employ methods, like topic modeling or extractive summarization. The resulting summaries enable efficient comparison between queries and index contents and facilitate accurate routing decisions in the query router 140.

In one or more embodiments, the query router 140 processes an incoming query from the RAG agent 110. The query router 140 tokenizes the query into individual terms or phrases. The query router 140 consults the routing index 142 for each query element. It retrieves matching entries from the index summaries 144. The query router 140 computes relevance scores for each potential target index. The query router 140 uses techniques, such as TF-IDF or cosine similarity, for scoring. The query router 140 applies a threshold to filter out low-relevance indexes. The query router 140 ranks the remaining indexes based on their relevance scores. The query router 140 may consider additional factors, like index size and update frequency. The query router 140 may use a weighted combination of multiple relevance metrics. The query router 140 may select the top-N indexes as the target set or select indexes with relevance scores above a predefined threshold. The query router 140 may optimize the selection based on system-defined parameters and may apply query expansion techniques for better matching. The query router 140 may handle edge cases like queries with no high-relevance matches. The query router 140 generates a final list of target indexes for the query and passes this list to the retriever 150 for content item retrieval. The entire process occurs rapidly to minimize query latency.

In one or more embodiments, the query router 140 receives a query and tokenizes it into individual terms. The query router 140 calculates the TF for each query term. The query router 140 accesses the routing index 142 to retrieve IDF values. The query router 140 computes TF-IDF scores for each term across index summaries 144. The query router 140 normalizes these scores to account for summary length differences. The query router 140 aggregates the TF-IDF scores for each index summary. The aggregation may use different methods like sum, average, or weighted combinations. The query router 140 ranks the indexes 132 based on their aggregated TF-IDF scores. The query router 140 applies a predefined threshold to filter low-scoring indexes. The query router 140 selects the top-N scoring indexes as target indexes or indexes that score above a predefined threshold. The query router 140 may consider system parameters, like processing capacity, for the top-N selection. The query router 140 may handle ties in scores using secondary criteria and may apply smoothing techniques to handle rare or unseen terms. The query router 140 generates a final ranked list of target indexes and passes this list to the retriever 150 for further processing. The TF-IDF approach balances term importance with index relevance and enables efficient and relevant index selection for diverse queries.

In one or more embodiments, the query router 140 receives a query and generates its semantic embedding. The query router 140 uses a pre-trained language model to create the query embedding. The query router 140 accesses pre-computed embeddings for each index summary 144. These embeddings are stored in the routing index 142 for efficient retrieval. The query router 140 computes cosine similarity (or other suitable similarity measure) between query and summary embeddings. The query router 140 performs this calculation for available or relevant index summaries. The query router 140 normalizes similarity scores to a standard range and ranks the indexes 132 based on their semantic similarity scores. The query router 140 applies a threshold to filter out low-similarity indexes and selects the top-N scoring indexes as the target set. The selection of N may consider system capacity and query complexity. The query router 140 may handle potential ties using secondary criteria and may employ dimensionality reduction techniques for efficient computation. The query router 140 generates a final list of semantically relevant target indexes. It passes this list to the retriever 150 for content retrieval. This approach captures semantic relationships beyond exact term matches. It enables more nuanced and context-aware index selection for queries.

In one or more embodiments, the retriever 150 is a component of the query processor 120 that performs information extraction from selected indexes 132. The retriever 150 ensures efficient and accurate information retrieval from multiple indexes. The retriever 150 receives routed queries from the query router 140. The retriever 150 formulates index-specific search requests for each target index. The retriever 150 executes these requests concurrently across selected indexes. The retriever 150 employs various search algorithms tailored to each index type. The retriever 150 may use inverted indexes or vector similarity searches. The retriever 150 handles different index formats and query languages as needed. The retriever 150 optimizes retrieval based on index characteristics and query types. The retriever 150 manages query timeouts and resource allocation across indexes. The retriever collects and standardizes results from the target indexes. The retriever 150 may implement caching mechanisms for frequently accessed content. The retriever 150 may apply initial filtering to remove irrelevant results. The retriever 150 handles error conditions and partial results from indexes. The retriever 150 prepares a standardized output for the result fuser 160.

In one or more embodiments, the retriever 150 receives a query and a list of target indexes from the query router 140. The retriever 150 formulates a standardized search request for the knowledge database system 130. The retriever 150 may adapt the query syntax for each selected index. The retriever 150 creates parallel search tasks for each selected index. The retriever 150 submits these tasks concurrently to the knowledge database system 130. The retriever 150 sets appropriate timeouts for each search operation. The retriever 150 manages connection pools for efficient database interactions. The retriever 150 handles potential network latency and connection errors. The retriever 150 receives results from each index asynchronously. The retriever 150 collects and buffers partial results as they arrive. The retriever 150 applies initial filtering to remove irrelevant items. The retriever 150 standardizes the format of results from different indexes. The retriever 150 handles pagination if result sets are large. The retriever 150 may implement early termination if sufficient results are found. The retriever 150 aggregates results from searched indexes and prepares a unified result set for further processing. The retriever 150 passes the collected results to the result fuser 160 for combination.

The knowledge database system 130 is a distributed data storage and retrieval system. The knowledge database system 130 provides an information repository for the RAG agent 110's knowledge augmentation process. The knowledge database system 130 comprises indexes 132 for diverse data types. An index may be optimized for specific content characteristics and query patterns. The knowledge database system 130 supports various indexing structures, like inverted indexes or vector stores. The knowledge database system 130 may implement data partitioning and replication strategies and provide high-throughput, low-latency query processing capabilities. The knowledge database system 130 may support concurrent access from multiple retriever 150 instances. The knowledge database system 130 may employ robust consistency and data integrity mechanisms. The knowledge database system 130 may include features for real-time updates and index maintenance. The knowledge database system 130 may scale horizontally to accommodate growing data volumes. The knowledge database system 130 may implement advanced caching mechanisms for frequently accessed data. The knowledge database system 130 supports query operations across multiple indexes 132. The knowledge database system 130 may provide interfaces for both exact and approximate (fuzzy) matching. The knowledge database system 130 may include monitoring and logging functionalities for performance analysis and may implement access controls and data encryption for security. The knowledge database system 130 integrates with other components through APIs.

In one or more embodiments, the knowledge database system 130 supports a flexible search architecture. The knowledge database system 130 supports keyword-based searches using inverted index structures. The knowledge database system 130 employs tokenization and stemming for efficient keyword matching. Additionally, or alternatively, the knowledge database system 130 incorporates semantic embedding-based searches using vector representations. These embeddings capture semantic relationships between terms and documents. The knowledge database system 130 uses approximate nearest neighbor algorithms for vector similarity searches. Additionally, or alternatively, the knowledge database system 130 supports hybrid searches that combine both keyword and embedding approaches. The knowledge database system 130 may implement a unified query interface for various search types. The knowledge database system 130 may dynamically select the appropriate search method based on query characteristics. The knowledge database system 130 optimizes index structures for a search type. For example, the database 103 may use specialized data structures, such as like locality-sensitive-hashing (LSH) forests, for embedding searches. The knowledge database system 130 may allow for custom weighting between keyword and semantic components. The knowledge database system 130 may provide configurable thresholds for relevance scoring in hybrid searches. The knowledge database system 130 may support real-time updates to both keyword and embedding indexes. The knowledge database system 130 may implement efficient caching mechanisms for frequent queries of various types. The knowledge database system 130 may offer query expansion capabilities for enhanced semantic matching and may provide relevance scores for results from a search method.

In one or more embodiments, the indexes 132 create structured representations of content items 182. The indexing structures are optimized for fast retrieval and minimal storage overhead. The content items 182 are stored in the content item store 180. An index may be optimized for specific content item types and query patterns. The indexing process extracts key features from the content items 182 and may create inverted lists mapping features to content item identifiers. For text-based content items, indexes 132 may use techniques, like tokenization and stemming. Numeric data may be indexed using B-trees or R-trees for efficient range queries. Image content can be indexed using visual feature descriptors or embeddings. Audio content may be indexed based on spectral features or transcriptions. The indexes 132 support various content item types, like documents, images, and videos. The indexes 132 handle structured data, such as database records or JSON objects. Unstructured text from web pages or articles can also be indexed. The indexing process may normalize data for consistent representation across types. The indexing process may generate metadata to facilitate efficient filtering and sorting. The indexes 132 may maintain references to the content items 182 in the content item store 180. The indexes 132 may support real-time updates to reflect changes in the content item store 180.

In one or more embodiments, the content item store 180 is a large-scale distributed storage system. It houses a diverse collection of content items 182. These content items 182 represent various types of information and data. The content item store 180 supports high-throughput read and write operations and may implement data replication for fault tolerance and availability. Content items 182 are discrete units of information within the store. They can be text documents, images, videos, or structured data records. A content item has a unique identifier for retrieval and referencing. Content items 182 may include metadata describing their properties and relationships. The content item store 180 may support versioning to track changes in content items 182 over time and may implement access control mechanisms to manage content item visibility. The content item store 180 may provide efficient bulk ingestion capabilities for large datasets. The content item store 180 may support both random access and sequential scanning of content items. The content item store 180 may use compression techniques to optimize storage utilization and may implement caching mechanisms for frequently accessed items. The content item store 180 may provide interfaces for adding, updating, and deleting content items 182 and may support transactional operations to ensure data consistency.

In one or more embodiments, content items 182 represent chunks or portions of larger content items. A chunking process divides large content into smaller, manageable pieces. These chunks become individual content items. The chunking process uses algorithms to create logical divisions in content. The algorithms may consider semantic boundaries, fixed sizes, or content-specific features. A chunk may retain a reference to its parent content item. Chunks can be stored directly in indexes 132 for efficient retrieval. Additionally, or alternatively, chunks may reside in the content item store 180. In this case, indexes 132 maintain references to these stored chunks. Unique identifiers may be assigned to a chunk content item, and a chunk content item may be associated with metadata about chunk position and relationships. Chunking enables more granular indexing and retrieval of information. Chunking also facilitates parallel processing of large content items. The chunking process can improve search precision by allowing targeted retrieval of relevant portions. Chunk size may be selected or optimized for the specific content type and use case. Reassembly of chunks into complete content items may be performed when needed. Consistency between chunks and their parent content items may be maintained (e.g., in content item store 180). Chunking enhances the scalability of content processing and storage.

In one or more embodiments, chunking addresses the context window size and token limitations of the LLM 115. Large language models have fixed-size input contexts, typically measured in tokens. These contexts limit the amount of text processable in a single operation. Chunking breaks large documents into smaller, manageable pieces. A chunk fits within the LLM 115's context window size. This approach allows processing of documents exceeding the token limit. Chunks are designed to preserve semantic coherence where possible. They may overlap to maintain context across chunk boundaries. Chunks can be processed sequentially or in parallel, and results from multiple chunks can be aggregated for comprehensive analysis. Chunking enables focused retrieval of relevant document sections and reduces noise from irrelevant portions of large documents. Chunking optimizes token usage within the LLM 115's capacity and allows for more efficient use of computational resources. Chunking facilitates targeted information extraction and summarization and enables the LLM 115 to handle documents of arbitrary length. Dynamic adjustment of chunk sizes based on content may be supported by the chunking process.

In one or more embodiments, the multi-tenant provider network 100 connects to an intermediate network 190. The intermediate network 190 serves as a communication channel and facilitates query transmission from end-user devices to the RAG agent 110. The intermediate network 190 implements secure protocols for data transfer and may use encryption to protect user queries during transmission. The intermediate network 190 supports various connection types from end-user devices, including mobile devices, desktops, and web applications. Intermediate network 190 may include load balancers that distribute incoming traffic and implement authentication mechanisms to verify end-user identities. The intermediate network 190 provides routing capabilities to direct queries to appropriate instances of the RAG agent 110. The intermediate network 190 may include caching layers to improve response times for frequent queries. The intermediate network 190 supports scalable architectures to handle varying query volume and integrates with the multi-tenant provider network 100's security infrastructure. Intermediate network 190 may implement rate limiting to prevent system overload and may provide logging and monitoring capabilities for system administrators. The intermediate network 190 may support both synchronous and asynchronous communication models and ensures low-latency transmission of user queries to the RAG agent 110.

In one or more embodiments, components shown in FIG. 1 as being within the multi-tenant provider network 100 can be external. The RAG agent 110 may operate as a standalone service outside the multi-tenant provider network 100. The LLM 115 can be hosted on a separate specialized compute platform. The content item store 180 might exist as an independent cloud storage solution. The knowledge database system 130 could be maintained in a distinct data center. These external components would connect to the multi-tenant provider network 100 via secure APIs and intermediate network 190 or other networks. The external components would maintain data exchange protocols with internal network elements. External hosting allows for specialized hardware optimizations for a component, enables integration with third-party services or proprietary systems, and supports hybrid cloud or multi-cloud architectures for enhanced flexibility. External components can be managed by different teams or organizations. They may operate under distinct security and compliance regimes. This separation can enhance data sovereignty and regulatory compliance as well as facilitate easier updates and maintenance of individual components. The external setup supports multi-cloud strategies for redundancy and performance and enables scaling of specific components based on demand.

In one or more embodiments, the techniques disclosed herein are generalized to non-RAG and single-tenant systems for advanced information retrieval and processing. In such systems, a query processor receives queries from client applications and employs a multi-stage approach to retrieve relevant information. The query router analyzes incoming queries and selects appropriate target indexes based on index summaries. These summaries capture essential characteristics of an index, enabling efficient routing decisions. The retriever then executes the query across selected indexes, optimizing search operations for an index type. Results from multiple indexes are fused into a unified set that undergoes reranking to prioritize the most relevant content items.

The knowledge database in this generalized system can be structured as a distributed storage and retrieval system with multiple specialized indexes. These indexes support various data types and query patterns, employing structures like inverted indexes or vector stores for efficient retrieval. The system can implement flexible search architectures, combining keyword-based and semantic embedding-based approaches. Content items may be chunked into smaller, manageable pieces to facilitate granular indexing and retrieval. This approach addresses limitations in processing large documents and enables more focused information extraction. The entire system can be designed to scale horizontally, handle concurrent access, and maintain data integrity and security. Components may be distributed across different environments or hosted externally, allowing for specialized optimizations and supporting hybrid or multi-cloud architectures.

### 3. Method for Advanced Routing and Multi-Index Fusion for Enhanced Retrieval Augmented Generation

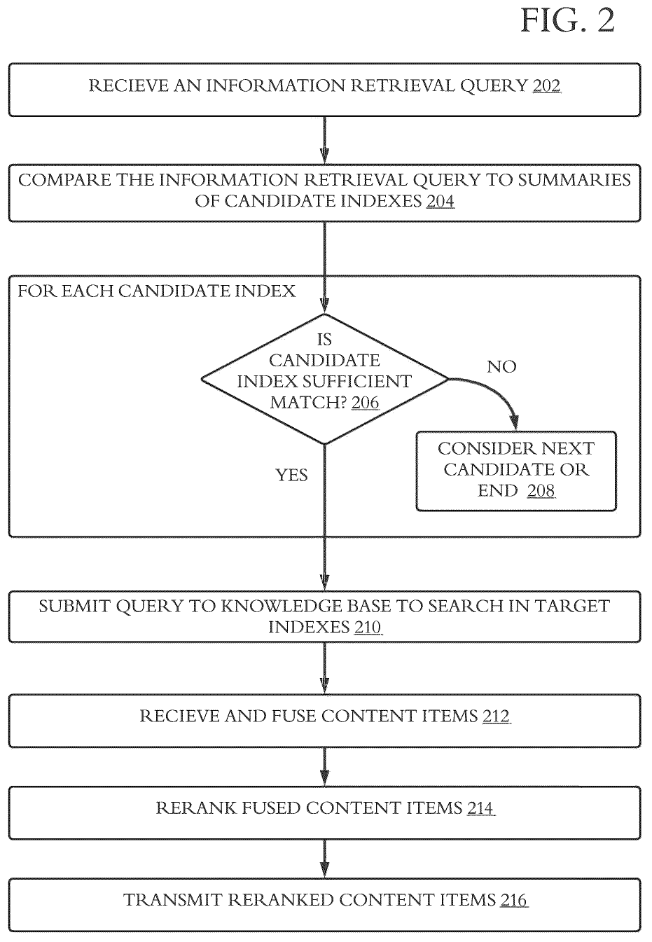

FIG. 2 is a flowchart of a method for advanced routing and multi-index fusion for enhanced retrieval augmented generation in accordance with an embodiment of the present disclosure. In one or more embodiments, the method of FIG. 2 is performed by a query processor (e.g., query processor 120).

The method of FIG. 2 operates on a knowledge database system (e.g., knowledge database system 130) with multiple indexes (e.g., indexes 132). The query processor receives an information retrieval query sent by a RAG agent (e.g., RAG agent 110). This query is compared to summaries (e.g., summaries 124) of the available indexes. A set of target indexes is selected based on this comparison. The query is then submitted to search within the selected target indexes. Sets of relevant content items are received from the target indexes. These sets are fused into a single combined set. The fused set undergoes reranking to produce a final reranked set. This reranked set is sent back to the RAG agent system. The method employs query routing to select relevant indexes. It combines this with multi-index fusion and reranking. The goal is to retrieve more relevant and precise information for the RAG system. This approach aims to improve RAG performance when dealing with large-scale distributed datasets.

In one or more embodiments, the query processor receives an information retrieval query (Operation 202). This query aims to retrieve information from the knowledge database system. The knowledge database system contains multiple indexes. The information retrieval query originates from the RAG agent system. RAG systems combine retrieval and generation techniques. The query serves as input for searching the knowledge database. The query represents the RAG agent's information need.

The query processor compares the received query to summaries of multiple indexes (Operation 204). An index has a corresponding summary. These summaries represent the content of their respective indexes. The comparison evaluates the query's relevance to an index. Based on this comparison, the query processor selects a set of target indexes. Target indexes are those deemed most relevant to the query. This comparison implements a query routing mechanism by narrowing down the search space to specific indexes. The comparison aims to improve search efficiency by focusing the subsequent retrieval on the most promising data sources for the query.

In one or more embodiments, the comparison involves semantic embedding representations (Operation 204). The query processor generates one or more semantic embeddings for the query. The query processor also maintains semantic embeddings for an index summary in a routing index (e.g., routing index 122). The comparison process uses these embeddings. Query embeddings are compared to summary embeddings. This comparison occurs in a high-dimensional semantic space and measures the semantic similarity between query and summaries. The query processor selects target indexes based on this semantic comparison. Indexes with summaries most semantically similar (e.g., above a threshold similarity) to the query are chosen. This leverages the semantic meaning of queries and summaries, aims to improve the accuracy of index selection, and can capture nuanced relationships between queries and indexes, thereby enhancing the relevance of the selected target indexes.

In one or more embodiments, a method for implementing the comparison employs term matching for index selection (Operation 204). This method may be used in conjunction with, or as an alternative to, the semantic embedding approach. The query processor extracts terms from the information retrieval query. The query processor also maintains term sets for an index summary. The comparison process involves matching query terms to summary terms. The query processor identifies overlapping or matching terms between the query and summaries. The query processor selects target indexes based on this term matching. Indexes with summaries containing more matching terms are chosen. This approach uses explicit lexical overlap for relevance determination by focusing focuses on the presence of specific words or phrases. The method can quickly identify indexes with content directly related to the query and provides a computationally efficient selection mechanism. The approach may be particularly effective for queries with distinct, domain-specific terminology.

In one or more embodiments, generating the index summaries involves analyzing content items within an index. Key information is extracted from these content items. This extracted information forms the basis of the summary for an index. The process creates concise representations of index contents. These summaries encapsulate the core themes or topics of an index. The generation may occur prior to the query processor receiving any queries and prepares the system for efficient index selection. The summaries serve as compact proxies for their respective indexes. They enable rapid comparison by the query processor with incoming queries. This supports the index selection process and allows for quick assessment of index relevance without searching entire indexes (Operation 204).

In one or more embodiments, a specific approach for generating the index summaries utilizes an LLM for summary creation. The LLM is provided with content from an index. The LLM is prompted to generate a summary of this content. The LLM processes the input and produces concise summaries. These summaries capture key aspects of the indexed content. The LLM leverages its language understanding capabilities. The LLM extracts and synthesizes important information from the content. This process occurs for an index in the knowledge database. The resulting summaries serve as representations of index contents. They are used in the query routing process. The LLM-based approach aims for high-quality, coherent summaries and can capture nuanced themes within the indexed content.

In one or more embodiments, the query processor receives an incoming query from the RAG agent (Operation 202). The query processor initiates a comparison process with candidate index summaries (Operation 204). A summary represents the content of a specific index. The processor compares the query against the first candidate summary. The query processor employs a predefined matching algorithm to assess similarity. The algorithm may use semantic embeddings or term matching. A threshold determines if the match is sufficient (Operation 206). If the match exceeds the threshold, the query is deemed relevant (“YES” branch at operation 206). The processor then transmits the query to the knowledge database (Operation 210). The database searches the corresponding index for relevant content. If the match falls below the threshold, the candidate index is considered irrelevant to the query (“NO” branch at operation 206). The processor moves to the next candidate summary in the list (Operation 208). This comparison process repeats for a subsequent summary. It continues until summaries are exhausted (Operation 208). The process ends if no more summaries remain for comparison (Operation 208).

The query processor submits the information retrieval query to the knowledge database system (Operation 210). The submission targets the previously selected set of indexes. These target indexes were chosen based on their relevance to the query. The query processor instructs the knowledge database to search within a selected index for information relevant to the submitted query. This initiates the actual retrieval process within the database and focuses the search on the most promising data sources. The approach aims to optimize retrieval efficiency by narrowing the search scope to potentially relevant indexes. This targeted search can reduce processing time and resource usage.

The query processor receives search results from the knowledge database system and fuses them (Operation 212). The query processor obtains multiple sets of content items. A set corresponds to a target index that was searched. These content items are identified by the knowledge database as relevant to the original query. The relevance is determined based on the search algorithms of the knowledge database. The received sets contain information extracted from the respective indexes. A set may include various types of content, such as text, metadata, or references. The query processor collects these sets for further processing. The received sets form the basis for subsequent fusion and reranking operations.

The query processor takes the multiple sets of content items received from different indexes and combines these sets into a single, unified set (Operation 212). This fusion process merges information from various sources and eliminates duplicate content items across the sets. The query processor may apply normalization techniques to standardize the content format. The query processor may also resolve conflicts between similar items from different indexes. The fusion aims to create a comprehensive, non-redundant set of results. This reduces data fragmentation across multiple indexes and prepares the content for subsequent reranking operations. The fused set represents a consolidated view of relevant information.

In one or more embodiments, a deduplication process is performed within the fusion step (Operation 212). The query processor identifies duplicate or near-duplicate content items across different sets and includes one of the duplicate or near-duplicate content items in the fused set that is passed to the reranker. This eliminates redundant information from multiple indexes, ensures a unique piece of content appears once, maintains information diversity in the fused set, and reduces (compresses) data volume without losing unique content, thereby improving the efficiency of subsequent processing steps.

In one or more embodiments, a deduplication process is performed within the fusion process (Operation 212). The deduplication process employs semantic embedding representations for content comparison. The query processor uses semantic embeddings for a content item. These embeddings capture the semantic meaning of the items. The query processor compares embeddings from different sets of content items and measures the semantic similarity between items across sets. The comparison uses a defined similarity metric in the embedding space. Items with high semantic similarity are identified as potential duplicates. The query processor retains one representative item from a group of similar items. This eliminates semantically redundant information across indexes and ensures the fused set contains diverse, non-repetitive content. The approach can detect duplicates even with textual variations, enhances the quality of the fused set by reducing semantic overlap, and contributes to a more concise and informative result set.

The query processor applies a reranking algorithm to the fused set (Operation 214). This algorithm reassesses the relevance of a content item, considering factors beyond the initial retrieval criteria. The reranking may incorporate query-specific relevance measures. The reranking may use machine learning models for scoring items. The reranking aims to optimize the order of content items by pushing the most relevant items to the top of the list. The reranking considers the global context of retrieved items and may adjust for diversity in the results. The query processor produces a new ordering of the content items. This reranked set represents the final relevance-based arrangement.

In one or more embodiments, a machine learning approach for the reranking process is used by the query processor (Operation 214). The query processor employs a trained machine learning model that is external to the knowledge database system. The model calculates a relevance score for a content item. The relevance score reflects the item's pertinence to the original query. The model analyzes features of both the query and content items and applies learned patterns to assess relevance. The query processor then uses these scores to reorder the fused set. Items with higher relevance scores are moved to higher positions. This reranking creates a new ordering of the content items. The approach leverages machine learning algorithms for relevance assessment to capture complex relationships between queries and content. The external model allows for independent updating to improve the quality of the final result set.

In one or more embodiments, a diversity-aware reranking approach is employed by the query processor (Operation 214). The query processor first determines the target information diversity of the query. This diversity measure indicates if the query is specific or general. The measure assesses the breadth of information the query seeks. The query processor then uses this diversity target in the reranking process by adjusting the ordering of content items based on the diversity goal. For specific queries, the query processor may prioritize closely related items or prioritize the top-N ranked content items regardless of source index even if content items in the top-N ranked content items are sourced from the same target index. For general queries, the query processor might favor a broader range of items from multiple indexes such that the top-N ranked items include at least one content item from a target index. The reranking balances relevance with information diversity. The reranking aims to match the result set's diversity to the query's intent. This approach can prevent over-representation of similar content and ensures the results cover an appropriate information spectrum based on the target information diversity of the query. The method tailors the reranking to the query's information needs and enhances the utility of the result set for both narrow and broad inquiries.

In one or more embodiments, a machine learning approach for determining the target information diversity of the query is used by the query processor. The query processor employs a trained machine learning model. This model analyzes the information retrieval query and assesses various features of the query text. The model determines the target information diversity and classifies the query on a spectrum from specific to general (e.g., a binary classification). This classification informs the subsequent reranking process. The machine learning approach can capture nuanced query characteristics and may consider various factors, like query length, term specificity, and semantic structure. The model's output guides the diversity-based reranking strategy and helps tailor the ranking of the result set to match the query's breadth.

In one or more embodiments, the query processor uses a selective reranking process (Operation 214). The query processor chooses a predetermined number (N) of top-ranked content items. It selects these items from the fused set based on relevance scores. The top-N items are included in the final reranked set. The query processor excludes items ranked below the top-N threshold. This truncates the result set and ensures a consistent size for the reranked output by focusing on the most relevant content items.

In one or more embodiments, the query processor employs a provenance-aware reranking process (Operation 214). The query processor receives provenance metadata for the fused content items that links an item to its source target index. The query processor uses this information in the reranking process to ensure representation from searched indexes in the final set, such as, for example, where the target information diversity of the query is general or broad as opposed to specific or narrow. The query processor selects at least one item from a target index. These selections contribute to the top-N items in the reranked set. By doing so, diversity across data sources is maintained. Furthermore, over-representation from any single index is prevented.

The query processor transmits processed results (operation 216). The query processor sends the reranked set of content items. This set represents the most relevant and organized information. The transmission is directed to the RAG agent system. The RAG agent is the original requester of the information. The sent data includes the reranked content items. These items are ordered based on relevance and other criteria. The transmission may include metadata about the ranking process. The transmission may also contain provenance information for an item. This completes the information retrieval cycle. The query processor delivers the refined results to the requesting agent. The RAG system receives this curated set of information. The RAG system can now use this data for further processing or for generation tasks.

The method of FIG. 2 can be generalized to non-RAG systems as an advanced multi-index information retrieval approach. In this generalized form, a query processor receives an information retrieval query from a client application. The processor compares the query against summaries of multiple indexes, using techniques, such as semantic embedding comparisons or term matching. Based on this comparison, the processor selects a set of target indexes deemed most relevant to the query. This query routing mechanism narrows the search space, improving efficiency by focusing retrieval on the most promising data sources.

The query processor then submits the query to search within the selected target indexes of a knowledge database system. Sets of relevant content items are received from a target index and fused into a single combined set. This fusion process may involve deduplication using semantic embeddings to eliminate redundant information. The fused set undergoes reranking that may employ machine learning models or diversity-aware approaches to optimize the order of content items. The reranking process can consider different factors, such as query-specific relevance measures, information diversity, and source representation. Finally, the query processor transmits the reranked set of content items to the requesting client application. This generalized method combines efficient query routing with multi-index fusion and intelligent reranking, enhancing the relevance and precision of information retrieval across diverse data sources in non-RAG contexts.

### 4. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

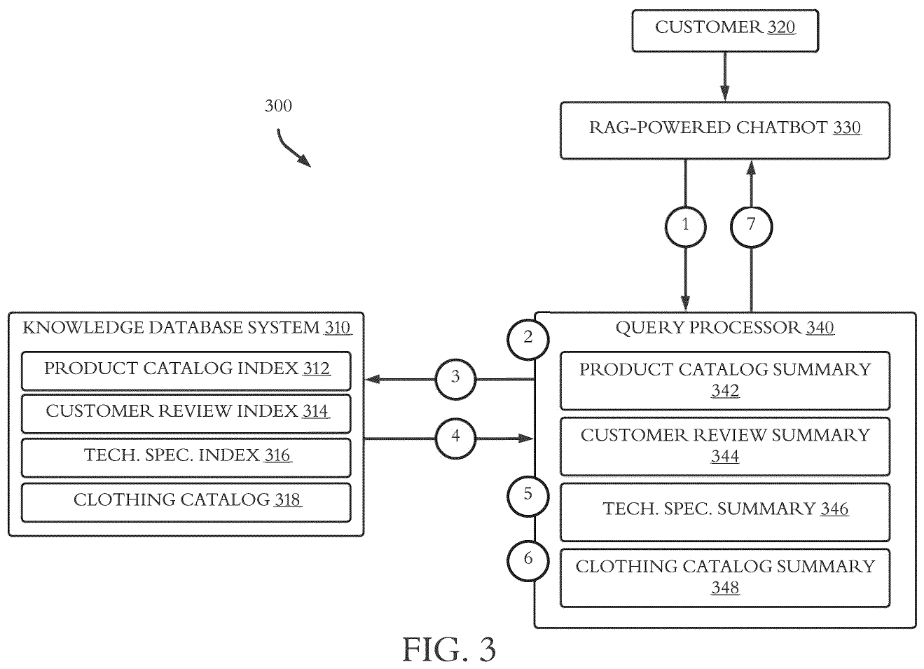

FIG. 3 illustrates an example of advanced routing and multi-index fusion for enhanced retrieval augmented generation in accordance with an embodiment of the present disclosure. Specifically, FIG. 3 illustrates operation 300 of an enterprise-scale e-commerce company that implements one or more embodiments to enhance customer support and product recommendations. The company's knowledge database system 310 contains multiple indexes: product catalogs 312, customer reviews 314, technical specifications 316, and clothing catalog 318. When a customer 320 interacts with the RAG-powered chatbot 330, the chatbot 330 generates an information retrieval query. This query is sent to the query processor 340 (Operation 1). The query processor 340 compares the query against summaries 342, 344, 346, and 348 of each index 312, 314, 316, and 318 (Operation 2). For a query about smartphone battery life, the processor 340 might select the product catalog 312, technical specifications 316, and customer reviews 314 as target indexes. The query is then submitted to search within these selected indexes (Operation 3). Relevant content items are retrieved from each index (Operation 4) and fused into a single set (Operation 5). This fused set undergoes reranking based on factors, like relevance score and recency (Operation 6). The final reranked set is sent back to the RAG agent (Operation 7), enabling the chatbot to provide accurate, context-aware responses about smartphone battery performance. Each of these operations is described in further detail below.

The approach described in this example reduces query latency by avoiding unnecessary searches in irrelevant indexes such as clothing catalogs. In addition, this approach reduces unnecessary utilization of computing resources (processing cycles, network bandwidth, etc.) that would otherwise be incurred by searching in irrelevant indexes. This approach also improves response quality by combining and refining information from multiple relevant sources. Consequently, the e-commerce company observes improved system performance, increased customer satisfaction, reduced support ticket volume, and higher conversion rates for product recommendations.

At Operation 1, the RAG-powered chatbot 330 employs natural language understanding (NLU) techniques to process the customer's input. The chatbot utilizes a pre-trained language model to parse and comprehend the customer's query about smartphone battery life. This model extracts key entities, intents, and contextual information from the input. The processed query is then vectorized using dense embedding techniques, creating a high-dimensional representation that captures semantic nuances. This vector, along with metadata, such as user session information and interaction history, is encapsulated in a standardized query object. The query object is serialized and transmitted to the query processor. Upon receipt, the query processor deserializes the object, validates its structure and metadata, and prepares for subsequent processing steps. This ensures that the customer's intent is accurately captured and formatted for efficient retrieval from the e-commerce company's knowledge database system 310.

At Operation 2, the query processor 340 employs comparison techniques to match the received query against summaries of the e-commerce company's multiple indexes 312, 314, 316, and 318. These summaries 342, 344, 346, and 348, stored as compact vector representations, encapsulate characteristics of each index 312, 314, 316, and 318, respectively. The processor 340 utilizes similarity algorithms, such as cosine similarity or approximate nearest neighbor search, to compare the query vector against these index summaries 342, 344, 346, and 348. For the smartphone battery life query, the query processor 340 calculates similarity scores between the query and each index summary 342, 344, 346, and 348. High similarity scores are observed for the product catalog 312, customer reviews 314 indexes, and technical specifications 316, while lower scores are noted for unrelated indexes like clothing catalogs 318. The processor 340 applies a thresholding mechanism to select the most relevant indexes, balancing between retrieval accuracy and computational efficiency. This selection process may use machine learning models trained on historical query patterns and index performance data. The chosen set of target indexes is then prepared for the subsequent search step with the selection metadata logged for future reference. By intelligently filtering the search space, Operation 2 reduces the computational load and improves the overall response time of the e-commerce company's customer support system.

At Operation 3, the query processor 340 initiates a distributed search operation across the selected target indexes 312, 314, and 316 within the e-commerce company's knowledge database system 310. The query processor 340 employs a parallel processing architecture to simultaneously query the product catalog 312, customer reviews 314 indexes, and technical specifications 316. Each index may utilize search algorithms optimized for its data structure and content type. For instance, the product catalog index 312 might use an inverted index with TF-IDF scoring, while the customer reviews index 314 could leverage a semantic search model based on sentence embeddings. The query may be dynamically adapted for each index, applying index-specific filters and boosting factors. To enhance search efficiency, the query processor 340 may utilize caching mechanisms and query expansion techniques. Load balancing techniques may be used to ensure optimal resource allocation across distributed index servers. As the search progresses, intermediate results may be streamed back to the query processor 340, allowing for early termination if sufficient relevant content is found. Operation 3 increases the relevance of retrieved information while reducing response time.

At Operation 4, the query processor 340 collects and aggregates the search results from the targeted indexes. The query processor 340 may employ a data streaming mechanism to efficiently receive content items or references thereto from distributed index servers. For the smartphone battery life query, the product catalog index 312 might return structured data on battery specifications, while the technical specifications index 316 provides detailed performance metrics. Concurrently, the customer reviews index 314 yields unstructured text data containing user experiences. Each set of content items or references thereto may be accompanied by metadata, including relevance scores, confidence intervals, and source information. The query processor 340 may utilize a dynamic buffer to manage the incoming data streams, allowing for real-time processing of results. To handle potential network latencies or server issues, the query processor 340 may implement a timeout mechanism with graceful degradation. Content items may be initially filtered by the query processor 340 based on predefined quality thresholds to eliminate low-relevance or potentially erroneous results. The processor 340 may then normalize the different data formats into a unified representation, facilitating subsequent processing steps. Operation 4 ensures that pertinent and high-quality information from each targeted index is collected.

At Operation 5, the query processor 340 executes a fusion algorithm to combine the disparate sets of content items into a cohesive, unified set. The fusion process may employ a multi-strategy approach, combining rule-based and machine learning techniques. For the smartphone battery life query, the query processor 340 may first align information across indexes using entity recognition and semantic matching. For example, structured data from the product catalog index 312 may be semantically linked with corresponding user reviews from the user review index 314 and technical specifications from the technical specifications index 316. The fusion algorithm may then apply a weighted combination method, considering different factors, such as source reliability, data freshness, and relevance scores. To handle potential conflicts or inconsistencies, the query processor 340 may utilize a truth discovery mechanism that probabilistically determines the most likely accurate information. The fused set undergoes de-duplication to remove redundant information, while preserving nuanced differences in content. Additionally, the fusion process may enrich the combined set with cross-referenced metadata, enhancing the context of each piece of information. Operation 5 results in a comprehensive, non-redundant set of content items that captures information about smartphone battery life from multiple perspectives.

At Operation 6, the query processor 340 applies a reranking algorithm to the fused set of content items, optimizing the order for relevance and utility. The reranking process may utilize a machine learning model trained on historical user interactions and expert-curated data. For the smartphone battery life query, the model may consider multiple features, such as textual relevance, semantic similarity, source credibility, information freshness, and user engagement metrics. The reranking algorithm may also incorporate context-aware factors, such as the customer's browsing history and preferences, to personalize the results. To handle the varied nature of content items, the query processor 340 may employ a multi-modal ranking approach, separately scoring structured specifications, unstructured reviews, and semi-structured product descriptions before combining them. The reranking process may also apply diversity optimization to ensure a balanced representation of different aspects of smartphone battery life. Additionally, the query processor 340 may use a real-time feedback loop to adjust rankings based on immediate user interactions. Operation 6 ensures that relevant, diverse, and personalized information about smartphone battery performance is prioritized.

At Operation 7, the query processor 340 prepares and transmits the reranked set of content items back to the RAG agent system 330. The processor 340 first serializes the reranked data into a standardized format, such as JSON or Protocol Buffers, optimizing for efficient network transfer. Metadata, including relevance scores, confidence intervals, and provenance information, may be appended to or associated with each content item. The query processor 340 may employ a chunking mechanism to handle large result sets, allowing for progressive loading and early display of high-priority information. To ensure data integrity during transmission, the processor 340 may apply error-checking algorithms and may implement a retry mechanism for failed transfers. The data stream may be compressed to minimize bandwidth usage. The transmission may be encrypted. The RAG agent system 330, upon receiving the data, acknowledges receipt, which may trigger performance metrics logging on the query processor 340 side. Operation 7 enables the e-commerce company's chatbot 330 to access the most relevant and refined information about smartphone battery life.

The entire operation 300 is facilitated and executed by the e-commerce company's high-performance computing infrastructure. This infrastructure may encompass distributed, load-balanced servers equipped with multi-core CPUs and specialized hardware accelerators, like GPUs or TPUs. Parallel processing techniques may be used for computationally intensive tasks, like index comparison and content fusion. The system's architecture may incorporate edge computing principles, distributing processing closer to data sources to reduce latency. The infrastructure enables the e-commerce company to handle high volumes of concurrent customer inquiries with minimal latency, ensuring a responsive and efficient customer support experience.

### 5. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. Custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

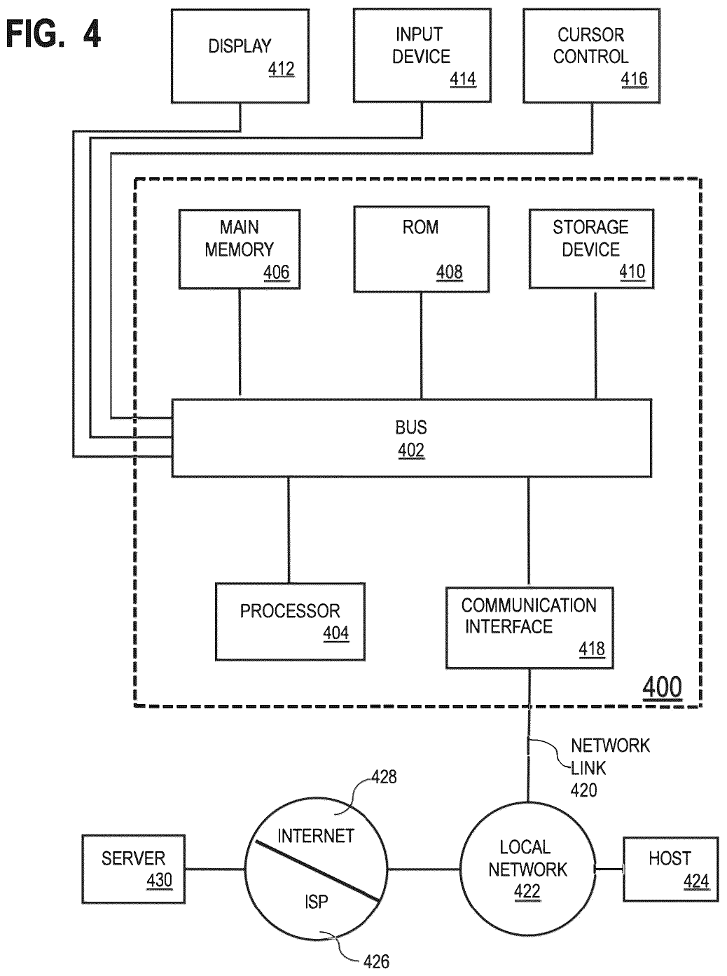

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general-purpose microprocessor.

Computer system 400 also includes a main memory 406, such as a random-access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid-State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 7. Miscellaneous; Extensions

Unless otherwise defined, all terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected, and efforts made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer-readable media comprising instructions which, when executed by one or more hardware processors, cause performance of operations comprising:
receiving an information retrieval query to retrieve information from a knowledge database system comprising a plurality of indexes, wherein the information retrieval query is sent by a retrieval augmented generation (RAG) agent system;
comparing the information retrieval query to a plurality of respective summaries of the plurality of indexes to select a set of target indexes of the plurality of indexes;
submitting the information retrieval query to the knowledge database system to search in each index of the set of target indexes for information relevant to the information retrieval query;
receiving sets of content items that the knowledge database system identified using the set of target indexes as relevant to the information retrieval query;
fusing the sets of content items to yield a fused set of content items;
reranking the fused set of content items to yield a reranked set of content items; and
sending the reranked set of content items, wherein the reranked set of content items is received by the RAG agent system.

2. The one or more non-transitory computer-readable media of claim 1, the operations further comprising:
comparing a set of one or more semantic embedding representations of the information retrieval query to a set of one or more respective semantic embedding representations of each summary of the plurality of respective summaries to select the set of target indexes.

3. The one or more non-transitory computer-readable media of claim 1, the operations further comprising:
matching a set of one or more terms of the information retrieval query to a set of one or more terms of the plurality of respective summaries to select the set of target indexes.

4. The one or more non-transitory computer-readable media of claim 1, the operations further comprising:
generating the plurality of respective summaries based on a set of content of a set of content items indexed by the plurality of indexes.

5. The one or more non-transitory computer-readable media of claim 4, the operations further comprising:
prompting a large language model to generate the plurality of respective summaries using the set of content.

6. The one or more non-transitory computer-readable media of claim 1, the operations further comprising:
determining a first set of one or more content items in the sets of content items that are each a duplicate or a near duplicate of a respective content item in a second set of one or more content items in the sets of content items;
including the second set of one or more content items in the fused set of content items; and
omitting the first set of one or more content items from inclusion in the fused set of content items.

7. The one or more non-transitory computer-readable media of claim 6, the operations further comprising:
comparing a respective set of one or more semantic embedding representations of each content item in the first set of one or more content items to a respective set of one or more semantic embedding representations of the respective content item in the second set of one or more content items to determine the first set of one or more content items.

8. The one or more non-transitory computer-readable media of claim 1, the operations further comprising:
using a trained machine learning model that is external to the knowledge database system to determine a respective relevance score for each content item in the fused set of content items reflecting relevance of the content item to the information retrieval query; and
reranking the fused set of content items to yield the reranked set of content items based on the respective relevance score for each content item in the fused set of content items.

9. The one or more non-transitory computer-readable media of claim 1, the operations further comprising:
determining a target information diversity of the information retrieval query; and
reranking the fused set of content items to yield the reranked set of content items based on the target information diversity.

10. The one or more non-transitory computer-readable media of claim 9, the operations further comprising:
applying a trained machine learning model to the information retrieval query to determine the target information diversity of the information retrieval query.

11. The one or more non-transitory computer-readable media of claim 1, the operations further comprising:
selecting a top-N number of content items in the fused set of content items for inclusion in the reranked set of content items; and
omitting at least one content item in the fused set of content items from inclusion in the reranked set of content items.

12. The one or more non-transitory computer-readable media of claim 11, the operations further comprising:
receiving a set of provenance metadata for the fused set of content items, wherein the set of provenance metadata indicates a respective target index of the set of target indexes for each content item in the fused set of content items in which the knowledge database system identified the content item as relevant to the information retrieval query; and
selecting at least one content item in the fused set of content items from each target index of the set of target indexes for inclusion in the top-N number of content items.

13. A method comprising:
receiving an information retrieval query to retrieve information from a knowledge database system comprising a plurality of indexes, wherein the information retrieval query is sent by a retrieval augmented generation (RAG) agent system;
comparing the information retrieval query to a plurality of respective summaries of the plurality of indexes to select a set of target indexes of the plurality of indexes;
submitting the information retrieval query to the knowledge database system to search in each index of the set of target indexes for information relevant to the information retrieval query;
receiving sets of content items that the knowledge database system identified using the set of target indexes as relevant to the information retrieval query;
fusing the sets of content items to yield a fused set of content items;
reranking the fused set of content items to yield a reranked set of content items;
sending the reranked set of content items, wherein the reranked set of content items is received by the RAG agent system; and
wherein the method is performed by at least one device including a hardware processor.

14. The method of claim 13, further comprising:
comparing a set of one or more semantic embedding representations of the information retrieval query to a set of one or more respective semantic embedding representations of each summary of the plurality of respective summaries to select the set of target indexes.

15. The method of claim 13, further comprising:
matching a set of one or more terms of the information retrieval query to a set of one or more terms of the plurality of respective summaries to select the set of target indexes.

16. The method of claim 13, further comprising:
generating the plurality of respective summaries based on a set of content of a set of content items indexed by the plurality of indexes.

17. A system comprising:
at least one device including a hardware processor;
the system being configured to perform operations comprising:
receiving an information retrieval query to retrieve information from a knowledge database system comprising a plurality of indexes, wherein the information retrieval query is sent by a retrieval augmented generation (RAG) agent system;
comparing the information retrieval query to a plurality of respective summaries of the plurality of indexes to select a set of target indexes of the plurality of indexes;
submitting the information retrieval query to the knowledge database system to search in each index of the set of target indexes for information relevant to the information retrieval query;
receiving sets of content items that the knowledge database system identified using the set of target indexes as relevant to the information retrieval query;
fusing the sets of content items to yield a fused set of content items;
reranking the fused set of content items to yield a reranked set of content items; and
sending the reranked set of content items, wherein the reranked set of content items is received by the RAG agent system.

18. The system of claim 17, the operations further comprising:
comparing a set of one or more semantic embedding representations of the information retrieval query to a set of one or more respective semantic embedding representations of each summary of the plurality of respective summaries to select the set of target indexes.

19. The system of claim 17, the operations further comprising:
matching a set of one or more terms of the information retrieval query to a set of one or more terms of the plurality of respective summaries to select the set of target indexes.

20. The system of claim 17, the operations further comprising:
generating the plurality of respective summaries based on a set of content of a set of content items indexed by the plurality of indexes.
